(19) United States
(12) Patent Application Publication
(10) Pub. No.: US 2020/0250515 A1
(43) Pub. Date: Aug. 6, 2020

(54) Systems and Methods for Improved Optimization of Machine-Learned Models

(71) Applicant: Google LLC, Mountain View, CA (US)

(72) Inventors: Ryan Rifkin, Oakland, CA (US); Ying Xiao, San Francisco, CA (US); Shankar Krishnan, Cupertino, CA (US)

(21) Appl. No.: 16/624,949

(22) PCT Filed: Jul. 6, 2018
(86) PCT No.: PCT/US2018/041033

§ 371 Date: Dec. 20, 2019

Related U.S. Application Data
(60) Provisional application No. 62/578,349, filed on Oct. 27, 2017.

(51) Int. Cl. G06N 3/04; G06N 3/08; G06N 20/00; G06F 17/16

(52) U.S. Cl. CPC G06N 3/0472; G06F 17/16; G06N 20/00; G06N 3/084

(57) ABSTRACT

Generally, the present disclosure is directed to systems and methods for improved optimization of machine-learned models. In particular, the present disclosure provides stochastic optimization algorithms that are both faster than widely used algorithms for fixed amounts of computation, and are also able to scale up substantially better as more computational resources become available. The stochastic optimization algorithms can be used with large batch sizes. As an example, in some implementations, the systems and methods of the present disclosure can implicitly compute the inverse hessian of each mini-batch of training data to produce descent directions.

### FIELD

The present disclosure relates generally to machine learning. More particularly, the present disclosure relates to systems and methods for improved optimization of machine-learned models such as, for example, deep neural networks.

### BACKGROUND

Progress in machine learning (e.g., deep learning) is slowed by the days or weeks it takes to train large models. The natural solution of using more hardware is limited by diminishing returns and leads to inefficient use of additional resources.

The current state of training deep neural networks is that simple mini-batch optimizers, such as stochastic gradient descent (SGD) and momentum optimizers, along with diagonal natural gradient methods, are by far the most used in practice. As distributed computation availability increases, total wall-time to train large models has become a substantial bottleneck, and approaches that decrease total wall-time without sacrificing model generalization are very valuable.

In the simplest version of mini-batch SGD, one computes the average gradient over a small set of examples, and takes a step in the direction of negative gradient. The convergence of the original SGD algorithm has two terms, one of which depends on the variance of the gradient estimate. Yet in practice, decreasing the variance by increasing the batch size often results in speedups that are sublinear with batch size, along with degraded generalization performance.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method includes accessing, by one or more computing devices, a batch of training examples. The method includes inputting, by the one or more computing devices, the batch of training examples into a machine-learned model to obtain a plurality of predictions. The machine-learned model includes a plurality of parameters. The method includes using, by the one or more computing devices, a power series expansion of an approximate inverse of a Hessian matrix to determine a descent direction for an objective function that evaluates the plurality of predictions relative to a plurality of targets. The method includes updating, by the one or more computing devices, one or more values of the plurality of parameters based at least in part on the determined descent direction.

In some implementations, using, by the one or more computing devices, the power series expansion of the approximate inverse of the Hessian matrix to determine the descent direction includes using, by the one or more computing devices, a Neumann series expansion of the approximate inverse of the Hessian matrix to determine the descent direction.

In some implementations, using, by the one or more computing devices, the power series expansion of the approximate inverse of the Hessian matrix to determine the descent direction includes iteratively updating a Neumann iterate for each training example included in the batch of training examples.

In some implementations, using, by the one or more computing devices, the power series expansion of the approximate inverse of the Hessian matrix includes using, by the one or more computing devices, the power series expansion of the approximate inverse of the Hessian matrix on the batch only.

In some implementations, using, by the one or more computing devices, the power series expansion of the approximate inverse of the Hessian matrix to determine the descent direction includes performing, by the one or more computing devices, an inner loop iteration that applies the approximate inverse of the Hessian matrix without explicitly representing the Hessian or computing a Hessian vector product.

In some implementations, the objective function includes one or both of a cubic regularizer and a repulsive regularizer.

In some implementations, using, by the one or more computing devices, the power series expansion of the approximate inverse of the Hessian matrix to determine the descent direction includes determining, by the one or more computing devices, a gradient at an alternate point that is different than a current point at which the one or more values of the plurality of parameters are currently located.

In some implementations, using, by the one or more computing devices, the power series expansion of the approximate inverse of the Hessian matrix to determine the descent direction includes using, by the one or more computing devices, the power series expansion to solve a linear system.

In some implementations, the method further includes: performing said accessing, inputting, using, and updating for each of plurality of additional batches of additional training examples.

In some implementations, the method further includes: prior to inputting the batch of training examples into the machine-learned model, performing a plurality of iterations of stochastic gradient descent on the machine-learned model.

In some implementations, the machine-learned model includes a neural network.

Another example aspect of the present disclosure is directed to a computer-implemented method. The method includes one or more training iterations. The following steps are performed for each of the one or more training iterations. The method includes obtaining, by one or more computing devices, a batch of training examples. The method includes inputting, by the one or more computing devices, the batch of training examples into a machine-learned model to obtain a plurality of predictions. The machine-learned model includes a plurality of parameters. The method includes determining, by one or more computing devices, a derivative of an objective function that evaluates the plurality of predictions relative to a plurality of targets. The method includes determining, by the one or more computing devices, an update based at least in part on the derivative of the objective function. The method includes updating, by the one or more computing devices, a power series iterate based at least in part on the update. The method includes updating, by the one or more computing devices, one or more values of the plurality of parameters based at least in part on the updated power series iterate.

In some implementations, the power series iterate is a Neumann iterate.

In some implementations, the method further includes updating, by the one or more computing devices, a moving average of the plurality of parameters based at least in part on the updated values of the plurality of parameters.

In some implementations, determining, by one or more computing devices, the update based at least in part on the derivative of the objective function includes determining, by the one or more computing devices, the update based at least in part on the derivative of the objective function and based at least in part on one or more regularization terms.

In some implementations, the one or more regularization terms comprise one or both of a cubic regularizer and a repulsive regularizer.

In some implementations, determining, by one or more computing devices, the update based at least in part on the derivative of the objective function includes determining, by the one or more computing devices, the update based at least in part on the derivative of the objective function and based at least in part on the moving average of the plurality of parameters.

In some implementations, updating, by the one or more computing devices, the power series iterate based at least in part on the update includes setting, by the one or more computing devices, the power series iterate equal to a previous iterative power series iterate times a momentum parameter minus the update times a learning rate parameter.

In some implementations, updating, by the one or more computing devices, the one or more values of the plurality of parameters includes setting, by the one or more computing devices, the values of the plurality of parameters equal to a previous iterative set of values plus the updated power series iterate times a momentum parameter minus the update times a learning rate parameter.

In some implementations, the method further includes returning, by the one or more computing devices, a final set of values for the plurality of parameters.

In some implementations, the final set of values for the plurality of parameters equals a most recently updated set of values for the plurality of parameters minus a most recent power series iterate times a momentum parameter.

In some implementations, the method can further include periodically resetting, by the one or more computing devices, the power series iterate value.

In some implementations, the machine-learned model includes a neural network.

In some implementations, the batch of training examples includes greater than sixteen thousand training examples.

In some implementations, the batch of training examples includes at least thirty-two thousand training examples.

Another example aspect of the present disclosure is directed to a computer system that includes one or more processors and one or more non-transitory computer-readable media that collectively store instructions that, when executed by the one or more processors, cause the computer system to perform one or more of the methods described herein.

Another example aspect of the present disclosure is directed to one or more non-transitory computer-readable media that collectively store instructions that, when executed by the one or more processors, cause the computer system to perform one or more of the methods described herein.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIGS. 1A-B depict example training and evaluation curves for Inception V3 according to example embodiments of the present disclosure.

FIGS. 2A-C depict example comparisons of Neumann optimizer with hand-tuned optimizer on different ImageNet models according to example embodiments of the present disclosure.

FIGS. 3A-B depict example scaling properties of Neumann optimizer versus SGD with momentum according to example embodiments of the present disclosure.

FIG. 4A depicts a block diagram of an example computing system according to example embodiments of the present disclosure.

FIG. 4B depicts a block diagram of an example computing device according to example embodiments of the present disclosure.

FIG. 4C depicts a block diagram of an example computing device according to example embodiments of the present disclosure.

FIG. 5 depicts a flow chart diagram of an example method to train machine-learned models according to example embodiments of the present disclosure.

FIG. 6 depicts a flow chart diagram of an example method to train machine-learned models according to example embodiments of the present disclosure.

FIG. 7 depicts a flow chart diagram of an example method to train machine-learned models according to example embodiments of the present disclosure.

Reference numerals that are repeated across plural figures are intended to identify the same features in various implementations.

### DETAILED DESCRIPTION

### 1. Overview

Generally, the present disclosure is directed to systems and methods for improved optimization of machine-learned models. In particular, the present disclosure provides stochastic optimization algorithms that are both faster than widely used algorithms for fixed amounts of computation, and are also able to scale up substantially better as more computational resources become available. The stochastic optimization algorithms can be used with large batch sizes. As an example, in some implementations, the systems and methods of the present disclosure can implicitly compute the inverse hessian of each mini-batch of training data to produce descent directions. This can be done without either an explicit approximation to the Hessian or Hessian-vector products. Example experiments are provided which demonstrate the effectiveness of example implementations of the algorithms described herein by successfully training large ImageNet models (e.g., Inception V3, Resnet-50, Resnet-101 and Inception-Resnet-V2) with mini-batch sizes of up to 32000 with no loss in validation error relative to current baselines, and no increase in the total number of steps. At smaller mini-batch sizes, the systems and methods of the present disclosure improve the validation error in these models by 0.8-0.9%. Alternatively, this accuracy can be traded off to reduce the number of training steps needed by roughly 10-30%. The systems and methods described herein are practical and easily usable by others. In some implementations, only one hyperparameter (e.g., learning rate) needs tuning. Furthermore, in some implementations, the algorithms described herein are as computationally cheap as the commonly used Adam optimizer. Thus, the systems and methods of the present disclosure provide a number of technical effects and benefits, including faster training and/or improved model performance. Stated differently, the models can be trained using fewer computing resources, thereby providing savings of computing resources such as processing power, memory space, or the like.

More particularly, the current state of training deep neural nets is that simple mini-batch optimizers, such as stochastic gradient descent (SGD) and momentum optimizers, along with diagonal natural gradient methods, are by far the most used in practice. As distributed computation availability increases, total wall-time to train large models has become a substantial bottleneck, and approaches that decrease total wall-time without sacrificing model generalization are very valuable.

In the simplest version of mini-batch SGD, one computes the average gradient of the loss over a small set of examples, and takes a step in the direction of the negative gradient. The convergence of the original SGD algorithm has two terms, one of which depends on the variance of the gradient estimate. In practice, decreasing the variance by increasing the batch size suffers from diminishing returns, often resulting in speedups that are sub-linear in batch size, and even worse, in degraded generalization performance.

The present disclosure provides systems and methods that, in some implementations, attack the problem of training with reduced wall-time via a novel stochastic optimization algorithm that uses second order information (e.g., limited second order information) without explicit approximations of Hessian matrices or even Hessian-vector products. In some implementations, on each mini-batch, the systems and methods of the present disclosure can compute a descent direction by solving an intermediate optimization problem, and inverting the Hessian of the mini-batch.

Explicit computations with Hessian matrices are extremely expensive. As such, the present disclosure provides an inner loop iteration that applies the Hessian inverse without explicitly representing the Hessian, or computing a Hessian vector product. In some implementations, one key aspect of this iteration is the Neumann series expansion for the matrix inverse, and an observation that allows each occurrence of the Hessian to be replaced with a single gradient evaluation.

Large-scale experiments were conducted using real models (e.g., Inception-V3, Resnet-50, Resnet-101, Inception-Resnet-V2) on the ImageNet dataset. The results of these example experiments are provided herein.

Compared to recent work, example implementations of the systems and methods described herein have favorable scaling properties. Linear speedup up to a batch size of 32000 was able to be obtained while maintaining or even improving model quality compared to the baseline. Additionally, when run using smaller mini-batches, example implementations of the present disclosure were able to improve the validation error by 0.8-0.9% across all the tested models. Alternatively, baseline model quality can be maintained while obtaining a 10-30% decrease in the number of steps.

Thus, the present disclosure provides an optimization algorithm (e.g., a large batch optimization algorithm) for training machine-learned models (e.g., deep neural networks). Roughly speaking, in some implementations, the systems and methods of the present disclosure implicitly invert the Hessian of individual mini-batches. Certain of the example algorithms described herein are highly practical, and, in some implementations, the only hyperparameter that needs tuning is the learning rate. Experimentally, it has been shown that example implementations of the optimizer are able to handle very large mini-batch sizes up to 32000 without any degradation in quality relative to current models trained to convergence. Intriguingly, at smaller mini-batch sizes, example implementations of optimizer are able to produce models that generalize better, and improve top-1 validation error by 0.8-0.9% across a variety of architectures with no attendant drop in the classification loss.

Example embodiments of the present disclosure will be discussed in further detail.

### 2. Example Algorithms

Let x∈ [symbol] ^{d} be the inputs to machine-learned model such as a neural network g(x, w) with some weights w∈ [symbol] ⁿ: the neural network is trained to learn to predict a target y∈ [symbol] which may be discrete or continuous. The network will be trained to do so by minimizing the loss function [symbol] _{(x,y)}[ [symbol] (y, g(x,w))] where x is drawn from the data distribution, and [symbol] is a per sample loss function. Thus, a goal is to solve the optimization problem

w*=argmin_{w} [symbol] _{(x,y)}[ [symbol] (y,g(x,w))].

If the true data distribution is not known (as is often the case in practice), the expected loss is replaced with an empirical loss. Given a set of N training samples (x₁, y₁), (x₂, y₂), . . . (x_{N}, y_{N})}, let fᵢ(w)= [symbol] (yᵢ, g(xᵢ, w)) be the loss for a particular sample xᵢ. Then the problem to be solved is

$${w}^{*} = {arg min}_{w} ( w ) = {arg min}_{w} \frac{1}{N} {\sum }_{i = 1}^{N} {f}_{i} ( w ) \qquad ( 1 )$$

Consider a regularized first order approximation of [symbol] (⋅) around the point wₜ:

$$𝒢 ( z ) = ( {w}_{t} ) + ∇ {( {w}_{t} )}^{T} ( z - {w}_{t} ) + \frac{1}{2 η} {‖ z - {w}_{t} ‖}^{2}$$

Minimizing G (⋅) leads to the familiar rule for gradient descent, wₜ₊₁=wₜ−η∇ [symbol] (wₜ). If the loss function is convex, one could instead compute a local quadratic approximation of the loss as

G (z)= [symbol] (wₜ)+∇F(wₜ)^{T}(z−wₜ)+½(z−wₜ)^{T}∇² [symbol] (wₜ)(z−wₜ), (2)

where ∇² [symbol] (wₜ) is the (positive definite) Hessian of the empirical loss. Minimizing G (z) gives the Newton update rule wₜ₊₁=wₜ−[∇² [symbol] (wₜ)]⁻¹∇ [symbol] (wₜ). This involves solving a linear system:

∇² [symbol] (wₜ)(w−wₜ)=−∇F(wₜ) (3)

One example algorithm provided by the present disclosure works as follows: on each mini-batch, a separate quadratic subproblem as in Equation (2) is formed. These subproblems can be solved using an iteration scheme as described in Section 2.1. Unfortunately, the naive application of this iteration scheme requires a Hessian matrix; Section 2.2 shows how to avoid this challenge. Practical modifications to the algorithm are described in Section 3.

2.1 Neumann Series

There are many way to solve the linear system in Equation (3). An explicit representation of the Hessian matrix is prohibitively expensive; thus a first attempt might be to use Hessian-vector products instead. Such a strategy might apply a conjugate gradient or Lanczos type iteration using efficiently computed Hessian-vector products via the Pearlmutter trick to directly minimize the quadratic form. In preliminary experiments with this idea, the cost of the Hessian-vector products overwhelms any improvements from a better descent direction. Thus, aspects of the present disclosure take an even more indirect approach, eschewing even Hessian-vector products.

At the heart of certain of the example methods described herein lies a power series expansion of the approximate inverse for solving linear systems. In particular, aspects of the present disclosure use the Neumann power series for matrix inverses—given a matrix A whose eigenvalues, λ(A) satisfy 0<λ(A)<1, the inverse is given by:

$${A}^{- 1} = {\sum }_{i = 0}^{∞} {( {I}_{n} - A )}^{i} .$$

This is the geometric series (1−r)⁻¹=1+r+r²+ . . . with the substitution r=(Iₙ−A). Using this, the linear system Az=b can be solved via a recurrence relation

z₀=b,zₜ₊₁=(Iₙ−A)zₜ+b, (4)

where it can easily be shown that zₜ→A⁻¹b. This is the Richardson iteration (Varga, Richard S. Matrix iterative analysis, volume 27. Springer Science & Business Media, 2009), and is equivalent to gradient descent on the quadratic objective.

2.2 Quadratic Approximations for Mini-Batches

A full batch method is impractical for even moderately large networks trained on modest amounts of data. The usual practice is to obtain an unbiased estimate of the loss by using a mini-batch. Given a mini-batch from the training set (xₜ_{₁}, yₜ_{₁}), . . . , (xₜ_{_{B}},yₜ_{_{B}}) of size B, let

$$\hat{f} ( w ) = \frac{1}{B} {\sum }_{i = 1}^{B} {f}_{{t}_{i}} ( w ) \qquad ( 5 )$$

be the function that is optimized at a particular step. Similar to Equation (2), the stochastic quadratic approximation for the mini-batch can be formed as:

\hat{f}(w)≈\hat{f}(wₜ)+∇\hat{f}^{T}(w−wₜ)+½(w−wₜ)^{T}[∇²\hat{f}](w−wₜ). (6)

As before, a descent direction can be computed by solving a linear system, [∇²\hat{f}](w−wₜ)=−∇\hat{f}, but now, the linear system is only over the mini-batch. To do so, one can use the Neumann series in Equation (4). Assume that the Hessian is positive definite (Section 3.1 shows how to remove the positive definite assumption), with an operator norm bound ∥∇²f∥<λₘₐₓ. Setting η<1/λₘₐₓ, the Neumann iterates mₜ can be defined by making the substitutions A=η∇²\hat{f}, zₜ=mₜ, and b=−∇\hat{f} into Equation (4):

$$\begin{matrix}{m}_{t + 1} = ( {I}_{n} - η {∇}^{2} \hat{f} ) {m}_{t} - ∇ \hat{f} ( {w}_{t} ) \\ = {m}_{t} - ( ∇ \hat{f} ( {w}_{t} ) + η {∇}^{2} \hat{f} {m}_{t} ) ) \\ \approx {m}_{t} - ∇ \hat{f} ( {w}_{t} + η {m}_{t} ) .\end{matrix} \qquad ( 7 )$$

The above sequence of reductions is justified by the following observation: the bold term on the second line is a first order approximation to ∇\hat{f}(wₜ+ηmₜ) for sufficiently small ∥ηmₜ∥ via the Taylor series:

∇\hat{f}²(wₜ+ηmₜ)=∇\hat{f}(wₜ)+η∇²\hat{f}mₜ+O(∥ηmₜ∥²).

This idea of gradient transport is one of the novel contributions of the present disclosure to make use of second order information in a practical way for optimization. By using first order only information at a point that is not the current weights, curvature information can be incorporated in a matrix-free fashion. This approximation is a primary reason that the slowly converging Neumann series is used—it allows for extremely cheap incorporation of second-order information. An example idealized Neumann algorithm is as follows:

### Example Algorithm 1 Idealized Two-Loop Neumann Optimizer

Input: Initial weights w₀ ∈ [symbol] ⁿ, input data x₁, x₂, . . . ∈ [symbol] ^{d}, input targets y₁, y₂, . . . ∈ [symbol] ,

| | learning rate η. |
|---|---|
| 1: | for t = 1, 2, 3, . . . T do |
| 2: | Draw a sample (xₜ_{₁}, yₜ_{₁}) . . . , (xₜ_{_{B}}, yₜ_{_{B}}). |
| 3: | Compute cubic regularized subproblem |
| | $\hat{g} ( m ) = \frac{1}{2} {m}^{T} {∇}^{2} \hat{f} ( {w}_{t} ) m + ∇ {\hat{f} ( {w}_{t} )}^{T} m + \frac{α}{3} {‖ m ‖}^{3}$ |
| 4: | // Solve convexified linear system using Neumann iteration |
| 5: | Compute derivative: m₀ = −η∇\hat{f}(wₜ) |
| 6: | for k = 1, . . . , K do |
| 7: | Update Neumann iterate: |
| | ${m}_{k} = ( 1 - αη ‖ {m}_{k - 1} ‖ ) {m}_{k - 1} - η ( \underbrace{∇ \hat{f} ( {w}_{t} ) + {∇}^{2} \hat{f} ( {w}_{t} ) {m}_{k - 1}}_{∇ \hat{f} ( {w}_{t} + {m}_{k - 1} )} ) .$ |
| 8: | Update weights wₜ = wₜ₋₁ + m_{K}. |
| 9: | return W_{T}. |

In some implementations, two different learning rates—an inner loop learning rate and an outer loop learning rate—can be used instead of the single learning rate shown in Algorithm 1.

The practical solution of Equation (6) is discussed further below. However, in view of the above description, one difference between the techniques described herein and the typical stochastic quasi-Newton algorithm is as follows: in an idealized stochastic quasi-Newton algorithm, one hopes to approximate the Hessian of the total loss ∇² [symbol] [fᵢ(w)] and then to invert it to obtain the descent direction [∇² [symbol] ᵢ[fᵢ(w)]]⁻¹∇\hat{f}(w). On the other hand, aspects of the present disclosure are content to approximate the Hessian only on the mini-batch to obtain the descent direction [∇²\hat{f}]⁻¹∇\hat{f}. These two quantities are fundamentally different, even in expectation, as the presence of the batch in both the Hessian and gradient estimates leads to a product that does not factor. One can think of stochastic quasi-Newton algorithms as trying to find the best descent direction by using second-order information about the total objective, whereas certain of the algorithms described herein try to find a descent direction by using second-order information implied by the mini-batch. While it is well understood in the literature that trying to use curvature information based on a mini-batch is inadvisable, the present approach is justified by noting that the curvature information arises solely from gradient evaluations, and that in the large batch setting, gradients have much better concentration properties than Hessians.

Two loop structures such as that included in Algorithm 1 have been used in the literature. However, one typically solves a difficult convex optimization problem in the inner-loop. In contrast, Algorithm 1 solves a much easier linear system in the inner-loop.

Here, instead of deriving a rate of convergence using standard assumptions on smoothness and strong convexity, the present disclosure moves onto the much more poorly defined problem of building an optimizer that works for large-scale deep neural nets.

### 3. An Example Optimizer for Machine-Learned Models Such as Neural Networks

Some practical problems associated with the Neumann optimizer are:

1. It was assumed that the expected Hessian is positive definite, and furthermore that the Hessian on each mini-batch is also positive definite.

2. There are a number of hyperparameters that significantly affect optimization learning, including the rate(s) η, inner loop iterations, and batch size.

Two separate techniques for convexifying the problem will be introduced—one for the total Hessian and one for mini-batch Hessians, and the number of hyperparameters will be reduced to just a single learning rate.

3.1 Convexification

In a deterministic setting, non-convexity in the objective can be dealt with through cubic regularization: adding a regularization term of

$$\frac{α}{3} {‖ w - {w}_{t} ‖}^{3}$$

to the objective function, where α is a scalar hyperparameter weight. It has been shown that under mild assumptions, gradient descent on the regularized objective converges to a second-order stationary point (i.e., Theorem 3.1). The cubic regularization method falls under a broad class of trust region methods. This term is essential to theoretically guarantee convergence to a critical point.

In some implementations, the present disclosure adds two regularization terms—a cubic regularizer,

$$\frac{α}{3} {‖ w - {v}_{t} ‖}^{3} ,$$

and a repulsive regularizer, β/∥w−vₜ∥ to the objective, where vₜ is an exponential moving average of the parameters over the course of optimization. The two terms oppose each other—the cubic term is attractive and prevents large updates to the parameters especially when the learning rate is high (in the initial part of the training), while the second term adds a repulsive potential and starts dominating when the learning rate becomes small (at the end of training). The regularized objective is

$$\hat{g} ( w ) = \hat{f} ( w ) + \frac{α}{3} {‖ w - {v}_{t} ‖}^{3} + β / ‖ w - {v}_{t} ‖$$

and its gradient is

$$∇ \hat{g} ( w ) = ∇ \hat{f} ( w ) + ( α {‖ w - {v}_{t} ‖}^{2} - \frac{β}{{‖ w - {v}_{t} ‖}^{2}} ) \frac{w - {v}_{t}}{‖ w - {v}_{t} ‖} \qquad ( 8 )$$

Even if the expected Hessian is positive definite, this does not imply that the Hessians of individual batches themselves are also positive definite. This poses substantial difficulties since the intermediate quadratic forms become unbounded, and have an arbitrary minimum in the span of the subspace of negative eigenvalues. Suppose that the eigenvalues of the Hessian, λ(∇²ĝ), satisfy λₘᵢₙ<λ(∇²ĝ)<λₘₐₓ, then define the coefficients:

$$( 1 - αη ‖ {m}_{t} ‖ ) = {μ}_{t} = \frac{{λ}_{m ax}}{\vert {λ}_{m i n} \vert + {λ}_{m ax}} ∝ 1 - \frac{1}{1 + t} and {η}_{t} = \frac{1}{{λ}_{m ax}} ∝ \frac{1}{t} .$$

In this case, the matrix \hat{B}=(1−μ)Iₙ+μη∇²ĝ is a positive definite matrix. If this matrix is used instead of ∇²\hat{f} in the inner loop, one obtains updates to the descent direction:

$$\begin{matrix}{m}_{k} = ( {I}_{n} - η \hat{B} ) {m}_{k - 1} - ∇ \hat{g} ( {w}_{t} ) \\ = ( μ {I}_{n} - μ η {∇}^{2} \hat{g} ( {w}_{t} ) ) {m}_{k - 1} - ∇ \hat{g} ( {w}_{t} ) \\ = μ {m}_{k - 1} - ( ∇ \hat{g} ( {w}_{t} ) + η μ {∇}^{2} \hat{g} ( {w}_{t} ) {m}_{k - 1} ) \\ \approx μ {m}_{k - 1} - η ∇ \hat{g} ( {w}_{t} + μ {m}_{k - 1} ) .\end{matrix} \qquad ( 9 )$$

It is not clear a priori that the matrix \hat{β} will yield good descent directions, but if |λₘᵢₙ| is small compared to λₘₐₓ, then the perturbation does not affect the Hessian beyond a simple scaling. This is the case later in training, but to validate it, an experiment was conducted where the extremal mini-batch Hessian eigenvalues were computed using the Lanczos algorithm. Over the trajectory of training, the following qualitative behavior emerges: Initially, there are many large negative eigenvalues; During the course of optimization, these large negative eigenvalues decrease in magnitude towards zero; and Simultaneously, the largest positive eigenvalues continuously increase (almost linearly) over the course of optimization.

This validates the mini-batch convexification routine. In principle, the cubic regularizer is redundant—if each mini-batch is convex, then the overall problem is also convex. But since λₘᵢₙ and λₘₐₓ are only crudely estimated, the cubic regularizer ensures convexity without excessively large distortions to the Hessian in \hat{B}. Based on the findings in the experimental study, the following setting is used:

$$μ ∝ 1 - \frac{1}{1 + t} ,$$

and η∝1/t.

3.2 Running the Optimizer: SGD Burn in and Inner Loop Iterations

Some example adjustments to the idealized Neumann algorithm are now proposed to improve performance and stability in training. As a first change, a very short phase of vanilla SGD is performed at the start. SGD is typically more robust to the pathologies of initialization than other optimization algorithms.

Next, there is an open question of how many inner loop iterations to take. Experiments have yielded the experience that there are substantial diminishing marginal returns to reusing a mini-batch. A deep network has on the order of millions of parameters, and even the largest mini-batch size is often less than fifty thousand examples. Thus, one cannot hope to rely on very fine-grained information from each mini-batch. From an efficiency perspective, the number of inner loop iterations should be kept relatively low; on the other hand, this leads to the algorithm degenerating into an SGD-esque iteration, where the inner loop descent directions mₜ are never truly useful.

This problem can be solved as follows: instead of freezing a mini-batch and then computing gradients with respect to this mini-batch at every iteration of the inner loop, we compute a stochastic gradient at every iteration of the inner loop. One can think of this as solving a stochastic optimization subproblem in the inner loop instead of solving a deterministic optimization problem. This small change is effective in practice, and also frees from having to carefully pick the number of inner loop iterations—instead of having to carefully balance considerations of optimization quality in the inner loop with overfitting on a particular mini-batch, the optimizer now becomes relatively insensitive to the number of inner loop iterations. A doubling schedule was selected for the experiments, but a linear one (e.g., as presented in Algorithm 2) works equally well. Additionally, since the inner and outer loop updates are now identical, a single learning rate η can be applied (rather than the alternative use of two different rates for the inner and outer loops).

Finally, there is the question of how to set the mini-batch size for the algorithm. Since one objective is to extract second-order information from the mini-batch, one possible interpretation is that the Neumann optimizer is better suited to the large batch setting, and that the mini-batch size should be as large as possible. Experimental evidence for this hypothesis is provided in Section 4.

### Example Algorithm 2 Neumann Optimizer

Learning rate η(t), cubic regularizer α, repulsive regularizer β, momentum μ(t), moving average parameter γ, inner loop iterations K

Input: Initial weights w₀ ∈ [symbol] ⁿ, input data x₁, x₂, . . . ∈ [symbol] ^{d}, input targets y1, y2, . . . ∈ [symbol] .

| | |
|---|---|
| 1: | Initialize moving average weights v₀ = w₀ and momentum weights m₀ = 0 |
| 2: | Run vanilla SGD for a small number of iterations. |
| 3: | for t = 1,2,3, . . . , T do |
| 4: | Draw a sample (xₜ_{₁}, yₜ_{₁}), . . . , (xₜ_{_{B}}, yₜ_{_{B}}). |
| 5: | Compute derivative ∇\hat{f} = (1/B) Σᵢ₌₁^{B} ∇ [symbol] (yₜ_{ᵢ}, g(xₜ_{ᵢ}, wₜ)) |
| 6: | if t = 1 modulo K then |
| 7: | Reset Neumann iterate mₜ = −η∇\hat{f} |
| 8: | else |
| 9: | $Compute update {d}_{t} = ∇ \hat{f} + ( α {‖ {w}_{t} - {v}_{t} ‖}^{2} - \frac{β}{{‖ {w}_{t} - {v}_{t} ‖}^{2}} ) \frac{{w}_{t} - {v}_{t}}{‖ {w}_{t} - {v}_{t} ‖}$ |
| 10: | Update Neumann iterate: mₜ = μ(t)mₜ₋₁ − η(t)dₜ. |
| 11: | Update weights: wₜ = wₜ₋₁ + μ(t)mₜ − η(t)dₜ. |
| 12: | Update moving average of weights: vₜ = wₜ + γ(vₜ₋₁ − wₜ) |
| 13: | return w_{T} − μ(T)m_{T}. |

As an implementation simplification, in some implementations, the wₜ maintained in Algorithm 2 are actually the displaced parameters (wₜ+μmₜ) in Equation (7). This slight notational shift then allows us to “flatten” the two loop structure with no change in the underlying iteration. In Table 1, a list of example hyperparameters that work across a wide range of models are compiled (all our experiments, on both large and small models, used these values): the only one that the user has to select is the learning rate.

TABLE 1
Summary of Hyperparameters.

| Hyperparameter | Setting |
|---|---|
| Cubic Regularizer | α = 10⁻⁷ |
| Repulsive Regularizer | β = 10⁻⁵ × numvariables |
| Moving Average | γ = 0.99 |
| Momentum | $μ ∝ ( 1 - \frac{1}{1 + t} ) ,$ |
| | starting at μ = 0.5 and peaking at μ = 0.9. |
| Number of SGD warm-up steps | numSGDsteps = 5 epochs |
| Number of reset steps | K, starts at 10 epochs, and doubles after |
| | every reset. |

### 4. Example Experiments

The optimizer was experimentally evaluated on several large convolutional neural networks for image classification. While the experiments were successful on smaller datasets (CIFAR-10 and CIFAR-100) without any hyperparameter modifications, results are reported only for the ImageNet dataset.

The experiments were run in Tensorflow, on Tesla P100 GPUs, in a distributed infrastructure. To abstract away the variability inherent in a distributed system such as network traffic, job loads, pre-emptions, etc., training epochs were used as the notion of time. Since the same amount of computation and memory was used as an Adam optimizer (Diederik Kingma and Jimmy Ba. Adam: A method for stochastic optimization. International Conference for Learning Representations, 2015), the step times are on par with commonly used optimizers. The standard Inception data augmentation (Szegedy et al., Inception-v4, inception-resnet and the impact of residual connections on learning. In AAAI, pp. 4278-4284, 2017) was used for all models. An input image size of 299×299 was used for the Inception-V3 and Inception-Resnet-V2 models, and 224×224 was used for all Resnet models. The evaluation metrics were measured using a single crop.

Neumann optimizer seems to be robust to different initializations and trajectories. In particular, the final evaluation metrics are stable and do not vary significantly from run to run, so results from single runs are presented throughout this experimental results section.

4.1 Fixed Mini-Batch Size: Better Accuracy or Faster Training

First, the Neumann optimizer was compared to standard optimization algorithms fixing the mini-batch size. To this end, for the baselines an Inception-V3 model (Szegedy et al., Rethinking the inception architecture for computer vision. In Proceedings of the IEEE Conference on Computer Vision and Pattern Recognition, pp. 2818-2826, 2016.), a Resnet-50 and Resnet-101 (He et al., Deep residual learning for image recognition. In Proceedings of the IEEE conference on computer vision and pattern recognition, pp. 770-778, 2016a and He et al., Identity mappings in deep residual networks. In European Conference on Computer Vision, pp. 630-645. Springer, 2016b.), and finally an Inception-Resnet-V2 (Szegedy et al., Inception-v4, inception-resnet and the impact of residual connections on learning. In AAAI, pp. 4278-4284, 2017) were trained. The Inception-V3 and Inception-Resnet-V2 models were trained as in their respective papers, using the RMSProp optimizer in a synchronous fashion, additionally increasing the mini-batch size to 64 (from 32) to account for modern hardware. The Resnet-50 and Resnet-101 models were trained with a mini-batch size of 32 in an asynchronous fashion using SGD with momentum 0.9, and a learning rate of 0.045 that decayed every 2 epochs by a factor of 0.94. In all cases, 50 GPUs were used. When training synchronously, the learning rate was scaled linearly after an initial burn-in period of 5 epochs where we slowly ramp up the learning rate, and decay every 40 epochs by a factor of 0.3 (this is a similar schedule to the asynchronous setting because 0.94²⁰≈0.3). Additionally, Adam was run to compare against a popular baseline algorithm.

TABLE 2
Final Top-1 Validation Error

| | Baseline | Neumann | Improvement |
|---|---|---|---|
| Inception-V3 | 21.7% | 20.8% | 0.91% |
| Resnet-50 | 23.9% | 23.0% | 0.94% |
| Resnet-101 | 22.6% | 21.7% | 0.86% |
| Inception-Resnet-V2 | 20.3% | 19.5% | 0.84% |

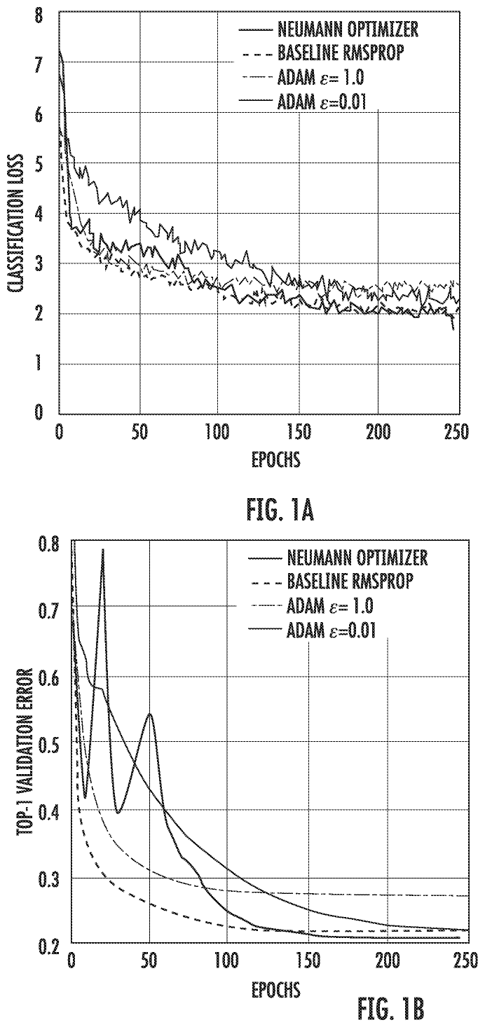

The optimizer was evaluated in terms of final test accuracy (top-1 validation error), and the number of epochs needed to achieve a fixed accuracy. FIGS. 1A-B provide the training curves and the test error for Inception V3 as compared to the baseline RMSProp.

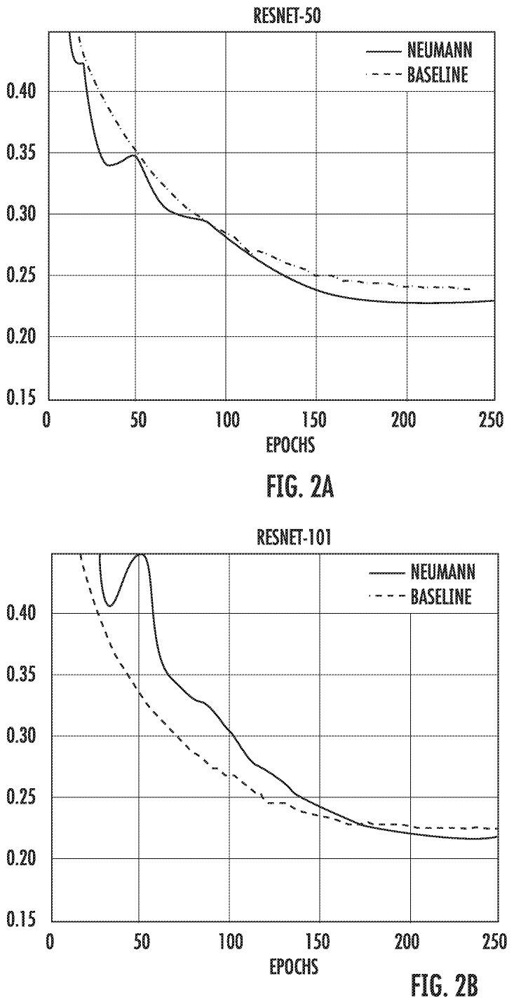

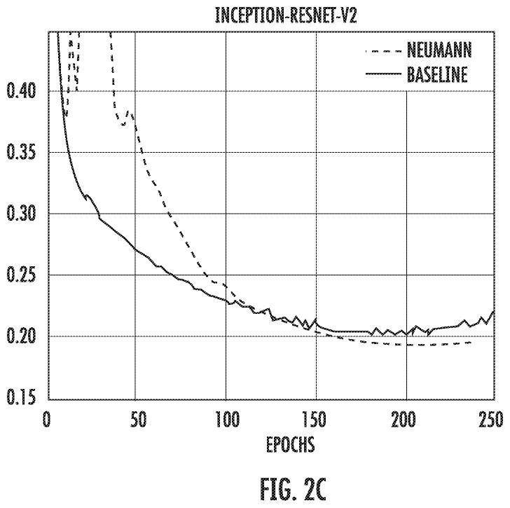

Some of the salient characteristics are as follows: first, the classification loss (the sum of the main cross entropy loss and the auxiliary head loss) is not improved, and secondly there are oscillations early in training that also manifest in the evaluation. The oscillations are rather disturbing, and it is hypothesized that they stem from slight mis-specification of the hyperparameter μ, but all the models that were train appear to be robust to these oscillations. The lack of improvement in classification loss is interesting, especially since the evaluation error is improved by a non-trivial increment of 0.8-0.9%. This improvement is consistent across all our models (see Table 2 and FIGS. 2A-C). FIGS. 2A-C provide example graphs that compare the Neumann optimizer with hand-tuned optimizer on different ImageNet models. It is unusual to obtain an improvement of this quality when changing from a well-tuned optimizer.

This improvement in generalization can also traded-off for faster training: if one is content to obtain the previous baseline validation error, then one can simply run the Neumann optimizer for fewer steps. This yields a 10-30% speedup whilst maintaining the current baseline accuracy.

On these large scale image classification models, Adam shows inferior performance compared to both Neumann optimizer and RMSProp. This reflects the understanding that architectures and algorithms are tuned to each other for optimal performance. For the rest of this section, Neumann optimizer will be compared with RMSProp only.

4.2 Linear-Scaling at Very Large Batch Sizes

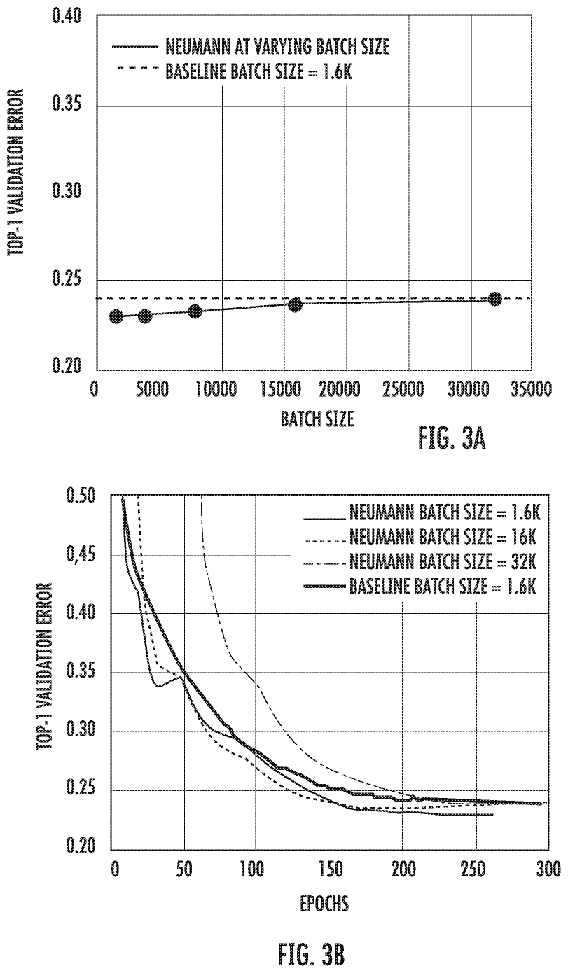

Earlier, it was hypothesized that the methods described herein are able to efficiently use large batches. This was studied by training a Resnet-50 on increasingly large batches (using the same learning rate schedule as in Section 4.1) as shown in FIG. 3B and Table 3. Each GPU can handle a mini-batch of 32 examples, so for example, a batch size of 8000 implies 250 GPUs. For batch sizes of 16000 and 32000, we used 250 GPUs, each evaluating the model and its gradient multiple times before applying any updates.

FIGS. 3A-B provides example graphs that demonstrate scaling properties of Neumann optimizer vs SGD with momentum.

The Neumann optimizer algorithm scales to very large mini-batches: up to mini-batches of size 32000, performance is still better than the baseline. Thus, the Neumann Optimizer is a new state-of-the-art in taking advantage of large mini-batch sizes while maintaining model quality. Compared to Goyal et al. (Accurate, large minibatch sgd: Training imagenet in 1 hour. arXiv preprint arXiv:1706.02677, 2017.) it can take advantage of 4× larger mini-batches; compared to You et al. (Scaling sgd batch size to 32 k for imagenet training. arXiv preprint arXiv:1708.03888, 2017a and Imagenet training in 24 minutes. arXiv preprint arXiv:1709.05011, 2017b) it uses the same mini-batch size but matches baseline accuracy while You et al. suffer from a 0.4-0.7% degradation.

TABLE 3
Scaling Performance of our Optimizer on Resnet-50

| | | Top-1 | | |
|---|---|---|---|---|
| Batch Size | # workers | Validation Error | # Epochs | Param. updates |
| 1600 | 50 | 23.0% | 226 | 181K |
| 4000 | 125 | 23.0% | 230 | 73.6K |
| 8000 | 250 | 23.1% | 258 | 41.3K |
| 16000 | 500 | 23.5% | 210 | 16.8K |
| 32000 | 1000 | 24.0% | 237 | 9.5K |

4.3 Effect of Regularization

The effect of regularization was studied by performing an ablation experiment (setting α and β to 0). The main findings are summarized in Table 4. It can be seen that regularization improves validation performance, but even without it, there is a performance improvement from just running the Neumann optimizer.

TABLE 4
Effect of regularization - Resnet-50, batch size 4000

| Method | Top-1 Error |
|---|---|
| Baseline | 24.3% |
| Neumann (without regularization) | 23.5% |
| Neumann (with regularization) | 23.0% |

### 5. Example Devices and Systems

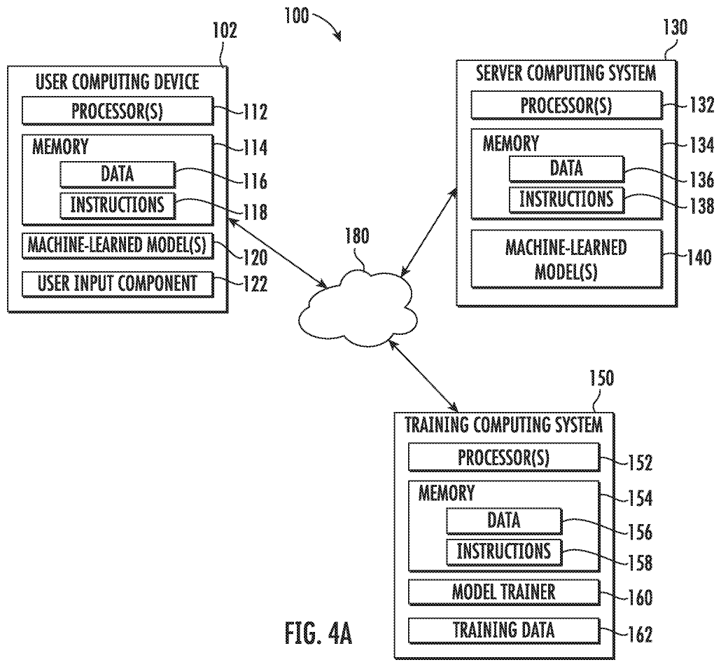

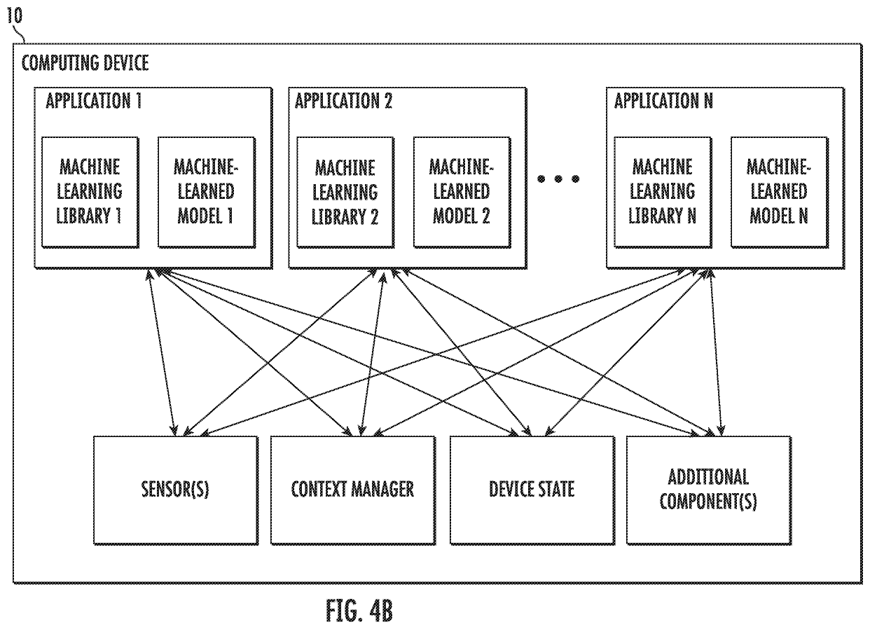

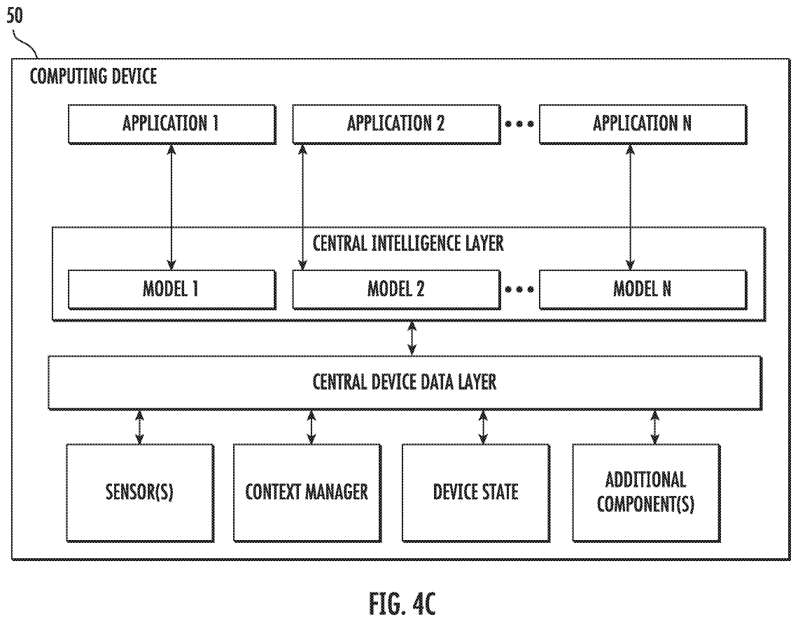

FIG. 4A depicts a block diagram of an example computing system 100 that includes machine-learned models according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

The user computing device 102 can store or include one or more machine-learned models 120. For example, the machine-learned models 120 can be or can otherwise include various machine-learned models such as neural networks (e.g., deep neural networks), other multi-layer non-linear models, or other models. Neural networks can include recurrent neural networks (e.g., long short-term memory recurrent neural networks), feed-forward neural networks, convolutional neural networks, or other forms of neural networks. While the present disclosure is discussed with particular reference to neural networks, the present disclosure is applicable to all kinds of machine-learned models, including, but not limited to, neural networks.

In some implementations, the one or more machine-learned models 120 can be received from the server computing system 130 over network 180, stored in the user computing device memory 114, and the used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receive user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can enter a communication.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise includes one or more machine-learned models 140. For example, the models 140 can be or can otherwise include various machine-learned models such as neural networks (e.g., deep recurrent neural networks), other multi-layer non-linear models, or other models.

The server computing system 130 can train the models 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 or 140 using various training or learning techniques, such as, for example, backwards propagation of errors. In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train a machine-learned model 120 or 140 based on a set of training data 142. The training data 142 can include, for example, a plurality of batches of training examples. In some implementations, each training example can have a target answer associated therewith.

In some implementations, the model trainer 160 can train the models 120 or 140 using the methods, techniques, and/or algorithms described herein (e.g., methods 200, 300, and/or 400, Algorithms 1 and/or 2, etc.).

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media. In some implementations, the model trainer (e.g., including performance of the optimization techniques described herein) can be provided as a service as part of a larger machine learning platform that enables users to receive machine learning services.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 4A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 4B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

### 6. Example Methods

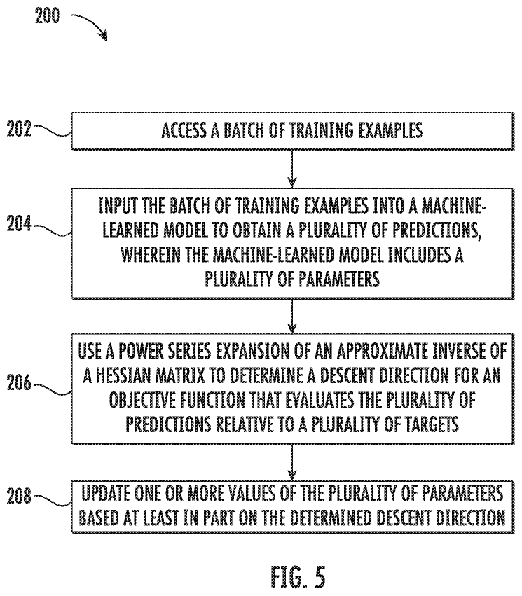

FIG. 5 depicts a flow chart diagram of an example method to perform according to example embodiments of the present disclosure. Although FIG. 5 depicts steps performed in a particular order for purposes of illustration and discussion, the methods of the present disclosure are not limited to the particularly illustrated order or arrangement. The various steps of the method 200 can be omitted, rearranged, combined, and/or adapted in various ways without deviating from the scope of the present disclosure.

At 202, a computing system can access a batch of training examples.

At 204, the computing system can input the batch of training examples into a machine-learned model to obtain a plurality of predictions. The machine-learned model can include a plurality of parameters.

At 206, the computing system can use a power series expansion of an approximate inverse of a Hessian matrix to determine a descent direction for an objective function that evaluates the plurality of predictions relative to a plurality of targets.

At 208 the computing system can update one or more values of the plurality of parameters based at least in part on the determined descent direction.

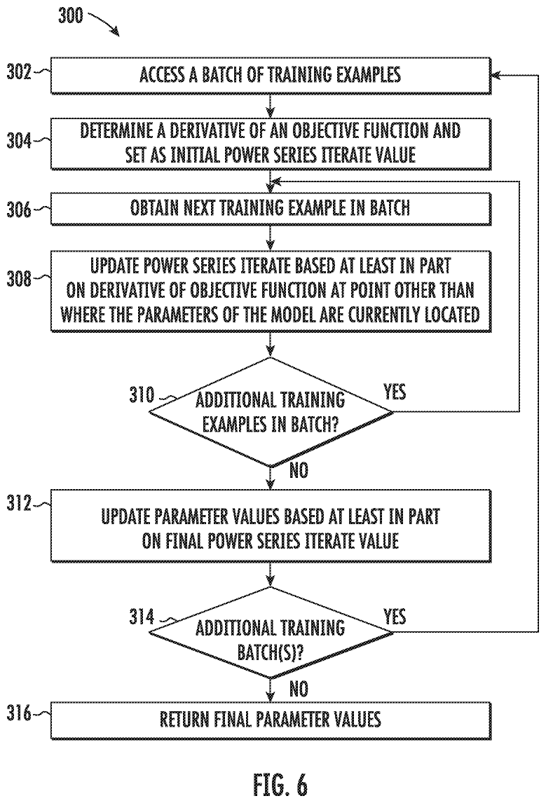

FIG. 6 depicts a flow chart diagram of an example method to perform according to example embodiments of the present disclosure. Although FIG. 6 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system accesses a batch of training examples.

At 304, the computing system determines a derivative of an objective function and sets the determined value as an initial power series iterate value.

At 306, the computing system obtains a next training example in the batch.

At 308, the computing system updates the power series iterate based at least in part on the derivative of the objective function at a point other than where the parameters of the model are currently located. For example, in some implementations, by using first order only information at a point that is not the current parameter values, the computing system can incorporate curvature information in a matrix-free fashion.

At 310, the computing system determines whether additional training examples are included in the batch. If so, the method returns to 306. If additional training examples do not remain in the batch, then the method proceeds to 312.

At 312, the computing system updates the parameter values based at least in part on the final power series iterate value.

At 314, the computing system determines whether additional training example batches are available and/or desired. If so, the method returns to 302. If additional batches are not available and/or desired, the method proceeds to 316.

At 316, the computing system returns the final parameter values.

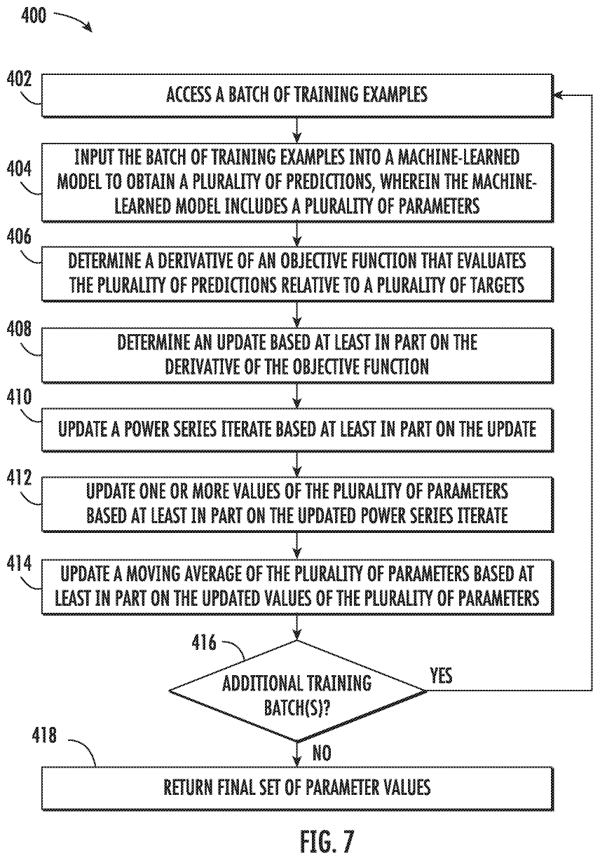

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a computing system can access a batch of training examples.

At 404, the computing system can input the batch of training examples into a machine-learned model to obtain a plurality of predictions. The machine-learned model can include a plurality of parameters.

At 406, the computing system can determine a derivative of an objective function that evaluates the plurality of predictions relative to a plurality of targets.

At 408, the computing system can determine an update based at least in part on the derivative of the objective function.

At 410, the computing system can update a power series iterate based at least in part on the update.

At 412, the computing system can update one or more values of the plurality of parameters based at least in part on the updated power series iterate.

At 414, the computing system can update a moving average of the plurality of parameters based at least in part on the updated values of the plurality of parameters.

At 416, the computing system can determine whether additional training example batches are available and/or desired. If so, the method returns to 402. If additional batches are not available and/or desired, the method proceeds to 418.

At 418, the computing system returns a final set of parameter values.

### 7. Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method, the method comprising:
accessing, by one or more computing devices, a batch of training examples;
inputting, by the one or more computing devices, the batch of training examples into a machine-learned model to obtain a plurality of predictions, wherein the machine-learned model comprises a plurality of parameters;
using, by the one or more computing devices, a power series expansion of an approximate inverse of a Hessian matrix to determine a descent direction for an objective function that evaluates the plurality of predictions relative to a plurality of targets; and
updating, by the one or more computing devices, one or more values of the plurality of parameters based at least in part on the determined descent direction.

2. The computer-implemented method of claim 1, wherein using, by the one or more computing devices, the power series expansion of the approximate inverse of the Hessian matrix to determine the descent direction comprises using, by the one or more computing devices, a Neumann series expansion of the approximate inverse of the Hessian matrix to determine the descent direction.

3. The computer-implemented method of claim 1, wherein using, by the one or more computing devices, the power series expansion of the approximate inverse of the Hessian matrix to determine the descent direction comprises iteratively updating a Neumann iterate for each training example included in the batch of training examples.

4. The computer-implemented method of claim 1, wherein using, by the one or more computing devices, the power series expansion of the approximate inverse of the Hessian matrix comprises using, by the one or more computing devices, the power series expansion of the approximate inverse of the Hessian matrix on the batch only.

5. The computer-implemented method of claim 1, wherein using, by the one or more computing devices, the power series expansion of the approximate inverse of the Hessian matrix to determine the descent direction comprises performing, by the one or more computing devices, an inner loop iteration that applies the approximate inverse of the Hessian matrix without explicitly representing the Hessian or computing a Hessian vector product.

6. The computer-implemented method of claim 1, wherein the objective function includes one or both of a cubic regularizer and a repulsive regularizer.

7. The computer-implemented method of claim 1, wherein using, by the one or more computing devices, the power series expansion of the approximate inverse of the Hessian matrix to determine the descent direction comprises determining, by the one or more computing devices, a gradient at an alternate point that is different than a current point at which the one or more values of the plurality of parameters are currently located.

8. The computer-implemented method of claim 1, wherein using, by the one or more computing devices, the power series expansion of the approximate inverse of the Hessian matrix to determine the descent direction comprises using, by the one or more computing devices, the power series expansion to solve a linear system.

9. The computer-implemented method of claim 1, further comprising:
performing said accessing, inputting, using, and updating for each of plurality of additional batches of additional training examples.

10. The computer-implemented method of claim 1, further comprising:
prior to inputting the batch of training examples into the machine-learned model, performing a plurality of iterations of stochastic gradient descent on the machine-learned model.

11. The computer-implemented method of claim 1, wherein the machine-learned model comprises a neural network.

12. A computer-implemented method, the method comprising, for each of one or more training iterations:
obtaining, by one or more computing devices, a batch of training examples;
inputting, by the one or more computing devices, the batch of training examples into a machine-learned model to obtain a plurality of predictions, wherein the machine-learned model comprises a plurality of parameters;
determining, by one or more computing devices, a derivative of an objective function that evaluates the plurality of predictions relative to a plurality of targets;
determining, by the one or more computing devices, an update based at least in part on the derivative of the objective function;
updating, by the one or more computing devices, a power series iterate based at least in part on the update; and
updating, by the one or more computing devices, one or more values of the plurality of parameters based at least in part on the updated power series iterate.

13. The computer-implemented method of claim 12, wherein the power series iterate comprises a Neumann iterate.

14. The computer-implemented method of claim 12, further comprising:
updating, by the one or more computing devices, a moving average of the plurality of parameters based at least in part on the updated values of the plurality of parameters.

15. The computer-implemented method of claim 12, wherein determining, by one or more computing devices, the update based at least in part on the derivative of the objective function comprises determining, by the one or more computing devices, the update based at least in part on the derivative of the objective function and based at least in part on one or more regularization terms.

16. The computer-implemented method of claim 15, wherein the one or more regularization terms comprise one or both of a cubic regularizer and a repulsive regularizer.

17. The computer-implemented method of claim 12, wherein determining, by one or more computing devices, the update based at least in part on the derivative of the objective function comprises determining, by the one or more computing devices, the update based at least in part on the derivative of the objective function and based at least in part on the moving average of the plurality of parameters.

18. The computer-implemented method of claim 12, wherein updating, by the one or more computing devices, the power series iterate based at least in part on the update comprises setting, by the one or more computing devices, the power series iterate equal to a previous iterative power series iterate times a momentum parameter minus the update times a learning rate parameter.

19. The computer-implemented method of claim 12, wherein updating, by the one or more computing devices, the one or more values of the plurality of parameters comprises setting, by the one or more computing devices, the values of the plurality of parameters equal to a previous iterative set of values plus the updated power series iterate times a momentum parameter minus the update times a learning rate parameter.

20. The computer-implemented method of claim 12, further comprising:
returning, by the one or more computing devices, a final set of values for the plurality of parameters.

21. The computer-implemented method of claim 20, wherein the final set of values for the plurality of parameters equals a most recently updated set of values for the plurality of parameters minus a most recent power series iterate times a momentum parameter.

22. The computer-implemented method of claim 12, further comprising:
periodically resetting, by the one or more computing devices, the power series iterate value.

23. The computer-implemented method of claim 12, wherein the machine-learned model comprises a neural network.

24-27. (canceled)
